(19) United States
(12) Patent Application Publication
(10) Pub. No.: US 2015/0122406 A1
(43) Pub. Date: May 7, 2015

(54) PROCESS FOR LAMINATING THIN GLASS LAMINATES

(71) Applicant: CORNING INCORPORATED, CORNING, NY (US)

(72) Inventors: William Keith Fisher, Suffield, CT (US); Michael John Moore, Corning, NY (US); Steven Luther Moyer, Lancaster, PA (US); Huan-Hung Sheng, Horseheads, NY (US); Larry Gene Smith, Tulsa, OK (US)

(21) Appl. No.: 14/405,668

(22) PCT Filed: Jun. 6, 2013
(86) PCT No.: PCT/US13/44493

§ 371 Date: Dec. 4, 2014

Related U.S. Application Data
(60) Provisional application No. 61/657,272, filed on Jun. 8, 2012.

(51) Int. Cl. B32B 37/10; B32B 37/18; B32B 37/06; C03B 23/035; C03C 27/10

(52) U.S. Cl. CPC B32B 37/1018; C03B 23/0357; C03C 27/10; B32B 37/06; B32B 37/182; B32B 2309/12; B32B 2309/68; B32B 2309/02; B32B 2315/08; B32B 2329/06; B32B 2331/04; B32B 2375/00; B32B 2250/03; B32B 2250/40; B32B 2307/10
USPC 156/222; 156/285

(57) ABSTRACT

A process using a vacuum ring or vacuum bag to produce glass laminates with improved optical distortion and shape consistency using thin glass having a thickness not exceeding 1.0 by using a soak temperatures not exceeding 120° C. or not exceeding 100° C. and a vacuum not exceed about −0.6 bar. One or more assembled stacks of two glass sheets and a polymer interlayer being laminated may be stacked on a single reference mold and processed simultaneously in a single vacuum bag or vacuum ring. One more thin glass sheets may be placed on top the assembled stack(s) on the reference mold to protect the assembled stack from irregular forces applied by the vacuum bag or the vacuum ring.

This application claims the benefit of priority under 35 U.S.C. §119 of U.S. Provisional Application Ser. No. 61/657,272 filed on Jun. 8, 2012 the content of which is relied upon and incorporated herein by reference in its entirety. This application is related to U.S. Provisional Application Ser. No. 61/659,533 filed on Jun. 14, 2012.

### BACKGROUND

1. Field

The present disclosure relates generally to processes for making thin glass laminates with improved optical distortion and shape consistency, and more particularly to an improved vacuum ring or vacuum bag process for making thin glass laminates with improved optical distortion and shape consistency.

2. Background

Glass laminates can be used as windows and glazing in architectural and vehicle or transportation applications, including automobiles, rolling stock, locomotive and airplanes. Glass laminates can also be used as glass panels in balustrades and stairs, and as decorative panels or covering for walls, columns, elevator cabs, appliances, electronic devices and other applications. Common types of glass laminates that are used in architectural and vehicle applications include clear and tinted laminated glass structures. As used herein, a glazing or a laminated glass structure (a glass laminate) is a transparent, semi-transparent, translucent or opaque part of a window, panel, appliance, electronic device, wall or other structure having at least one glass sheet laminated to a polymeric layer, film or sheet. However, glass laminates may also be used as a cover glass on signs, electronic displays, electronic devices and appliances, as well as a host of other applications.

Automotive glazing, laminated architectural glass and other glass laminates typically consist of two plies of 2 mm thick soda lime glass (heat treated or annealed) with a polyvinyl butyral (PVB) or other polymer interlayer. These glass laminates have certain advantages, including, low cost, and a sufficient impact resistance and stiffness for automotive and other applications. However, because of their limited impact resistance, these laminates usually have a poor behavior and a higher probability of breakage when getting struck by roadside stones, vandals and other impact events.

As the global fossil fuel reserves become depleted and prices get increasingly higher the world is looking for ways to reduce its energy and fuel consumption to conserve energy as well as to help mitigate possible global warming. For example, the automobile industries are looking for ways to increase mileage by reducing product weights and improving engine efficiency. One way to reduce the weight is by using thinner glass windows while preserving or even improving the performance of the window glass or glazing. Corning Incorporated has taken the lead and developed various thin yet very strong glasses such as Corning® Gorilla® glass to meet different future requirements. However, as glass sheets in laminates become thinner, the glass sheets become more pliable and more easily subject to deformation under stress, which often leads to optical distortion or shape variation when laminating such thin glass to form laminated glass products.

Typical glass lamination processes for the architectural and car window industries employ either vacuum bag or vacuum ring processes. In a typical vacuum bag process, the layers of the laminate are assembled in a stack, and the stack is wrapped in different films for lamination. There are release films to prevent stack/layers from sticking to the vacuum bag, breather films to facilitate vacuuming, and finally the vacuum bag to encase the sample in a vacuum environment for de-airing. On the other hand, in a typical vacuum ring process, a vacuum ring is used to seal the periphery of the stacked layers with a rubber ring seal, which has a built in vacuum line for vacuuming Both processes impose stress on the materials being lamented and subsequently create optical distortion and shape variations, especially when laminating thin glass sheets having a thickness not exceeding 1.0 mm.

There is a need for an apparatus and process for laminating thin glass laminate structures with improved optical distortion and shape consistency.

No admission is made that any reference cited herein constitutes prior art. Applicant expressly reserves the right to challenge the accuracy and pertinence of any cited documents.

### SUMMARY

The present disclosure describes a process using a vacuum ring or vacuum bag to produce laminated glass constructions with improved optical distortion and shape consistency when thin glass having a thickness not exceeding 1.0 mm is used in the laminate. The present disclosure also teaches variation of this process in which a reference mold may be optionally used to promote shape consistency for glass laminates made from all thin glass sheets, especially when a curved structure is being laminated. In other embodiments of the present disclosure, a plurality of constructions may be processed simultaneously using a single reference mold and single vacuum ring or vacuum bag.

Glass laminates that have been laminated using a conventional de-air and tack vacuum ring processes typically still need to be processed by an additional autoclave step at relatively high temperatures and pressures for satisfactory lamination. The present disclosure teaches how to utilize a vacuum ring or a vacuum bag process to directly produce transparent glass laminates with improved optical distortion and shape consistency when thin glass is used, thus eliminating the additional autoclave step at higher temperature and pressure to save time and resources.

According to one aspect of the present disclosure, a process is described that includes the steps of: providing a first glass sheet, a second glass sheet and a polymer interlayer, wherein at least one of the first glass sheet and the second glass sheet has a thickness not exceeding 1 mm; stacking the interlayer on the first glass sheet and stacking the second glass sheet on the interlayer forming an assembled stack; applying a vacuum to a peripheral edge of the assembled stack; heating the assembled stack to a soak temperature at or above the softening temperature of the interlayer; and maintaining the vacuum and the soak temperature for period of time (a soak time) sufficient to de-air the interlayer and tack the interlayer to the first glass sheet and the second glass sheet. Both the first glass sheet and the second glass sheet may have a thickness not exceeding 1 mm. Also, both the first glass sheet and the second glass sheet may be chemically strengthened glass sheets.

In some aspects hereof, the process further includes the step of placing the assembled stack in and autoclave at a pressure not exceeding 80 psi during the soak time. The soak temperature may not exceeding 150° C., about 120° C., about 100° C. or about 90° C. The vacuum applied to the peripheral edge of the assembled stack may not exceed about −0.9 bar, about −0.6 bar, about −0.5 bar or about −0.3 bar.

The step of applying a vacuum may be performed by clamping vacuum ring to the peripheral edge portion of the assembled stack and applying a vacuum in the vacuum ring.

The process as described herein may also include the steps of placing the assembled stack in and autoclave and maintaining a pressure within the autoclave in a range of from about 150 psi to about 200 psi during the soak time.

In some embodiments hereof the process may include the steps of providing a reference mold with a reference surface having shape substantially matching a desired shape of the glass laminate to form the assembled stack, and applying a vacuum applies a vacuum to the peripheral edge of the assembled stack including the reference mold. The process may optimally include the steps of stacking two or more assembled stacks on the reference surface of the reference mold; and the step of applying a vacuum applies a vacuum to the peripheral edge of all of the assembled stacks and the reference mold simultaneously.

In some embodiments hereof the process may include the step stacking at least one extra thin glass sheets on top of the assembled stack; and wherein the step of applying a vacuum includes placing the assembled stack in one of a vacuum bag and a vacuum ring and applying a vacuum to the one of a vacuum bag and a vacuum ring. The reference mold may be formed of a shaped soda lime glass sheet having a thickness of about 4 mm to about 6 mm thick.

The step of applying a vacuum may include placing the assembled stack in one of a vacuum bag and a vacuum ring and applying a vacuum to the one of a vacuum bag and a vacuum ring.

The interlayer may be formed of a polymer from the group consisting of standard polyvinyl butyral (PVB), acoustic PVB, ethylene vinyl acetate (EVA), thermoplastic polyurethane (TPU), or an ionomer.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments

### BRIEF DESCRIPTION OF THE DRAWINGS

FIG. 1 is a partial cross-sectional schematic illustration of a laminated glass structure according an embodiment of the present description;

FIGS. 2A, 2B, and 2C are schematic illustrations of a vacuum ring mold process for laminating thin glass laminates according to an embodiment of the present description;

FIGS. 3A and 3B are schematic illustrations of a vacuum ring mold process for laminating thin glass laminates according to another embodiment of the present description that employs a reference mold;

FIG. 4 is a schematic illustration of a vacuum ring mold process as in FIGS. 3A and 3B for laminating curved thin glass laminates;

FIG. 5 is a plot showing the shape of the initial glass sheets in the stack, reference mold, glass laminate after de-air and tack (e.g. immediately after laminating), and glass laminate after relaxation following de-air and tack (e.g. following lamination) in an autoclave according the present disclosure;

FIG. 6 is a schematic illustration of an embodiment hereof for laminating more than one laminated thin glass structure simultaneously; and

FIG. 7 is a schematic illustration of another embodiment hereof for laminating more than one laminated thin glass structure simultaneously.

### DETAILED DESCRIPTION

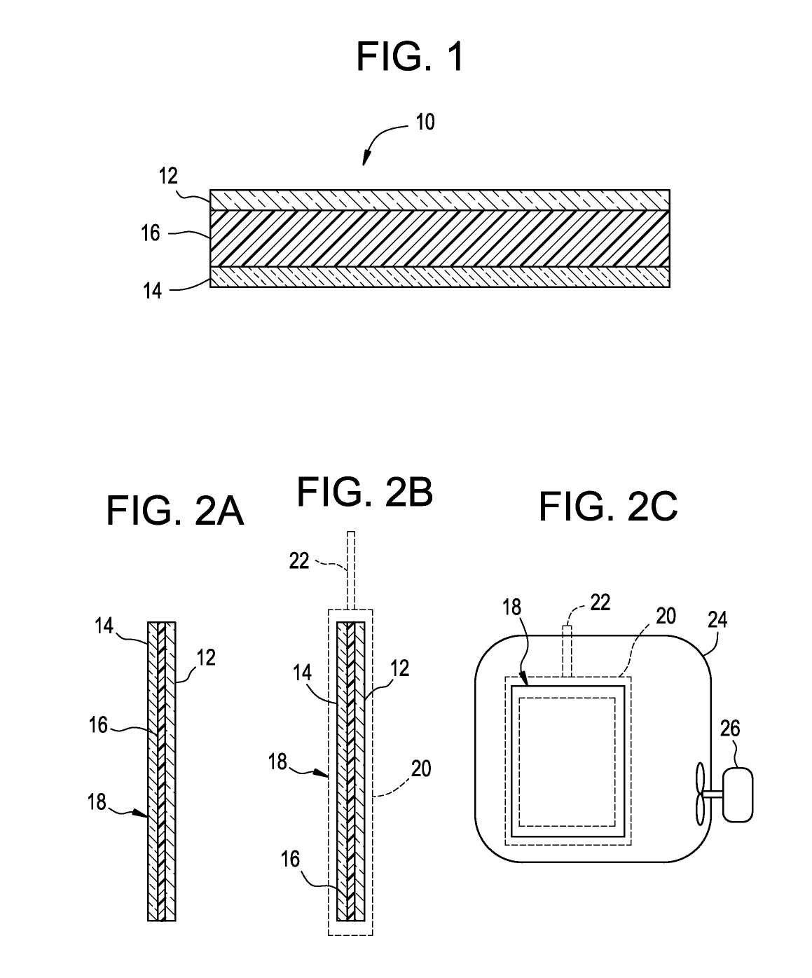

FIG. 1 is a partial cross-sectional schematic illustration (not to scale) of a thin glass laminate structure 10 according to an embodiment hereof. The thin glass laminate (or laminate or laminated structure) 10 may include two thin glass sheets 12 and 14 laminated one on either side of a polymeric interlayer 16. Alternatively, the thin glass laminate may include a single thin glass sheet and a second relatively thick glass sheet. The polymer interlayer 16 may be, by way of example only, standard PVB, acoustic PVB, ethylene vinyl acetate (EVA), thermoplastic polyurethane (TPU), or other suitable polymer or thermoplastic material. According to an embodiment hereof, at least one or both of the thin glass sheets may be formed of thin glass sheets that have been chemically strengthened using an ion exchange process, such as Corning® Gorilla® glass from Corning Incorporated. In this type of process, the glass sheets are typically immersed in a molten salt bath for a predetermined period of time. Ions within the glass sheet at or near the surface of the glass sheet are exchanged for larger metal ions, for example, from the salt bath. In one embodiment, the temperature of the molten salt bath is about 430° C. and the predetermined time period is about eight hours. The incorporation of the larger ions into the glass strengthens the sheet by creating a compressive stress in a near surface region. A corresponding tensile stress is induced within a central region of the glass sheet to balance the compressive stress.

The term “thin” as used in relation to the glass sheets in the present disclosure and the appended claims means glass sheets having a thickness not exceeding about 1.0 mm, not exceeding about 0.7 mm, not exceeding about 0.5 mm, or within a range from about 0.5 mm to about 1.0 mm or from about 0.5 mm to about 0.7 mm.

As described in U.S. Pat. Nos. 7,666,511, 4,483,700 and 5674790, Corning Gorilla glass is made by fusion drawing a glass sheet and then chemical strengthening the glass sheet. Corning Gorilla glass has a relatively deep depth of layer (DOL) of compressive stress, and presents surfaces having a relatively high flexural strength, scratch resistance and impact resistance. The glass sheets 12 and 14 and the polymer interlayer 16 may be bonded together during a lamination process according to the present disclosure in which the glass sheet 12, interlayer 16 and glass sheet 14 are stacked one on top of the other, and heated to a temperature somewhat above the softening temperature of the polymer interlayer 16, such that interlayer is adhered to the glass sheets.

A vacuum ring laminating process according to an embodiment hereof is schematically illustrated (not to scale) in FIGS. 2A through 2C. As shown in FIG. 2A, the process according the present description may include assembling two thin glass sheets 12 and 14 and polymer interlayer 16 into a stack 18 by placing the interlayer 16 on a first glass sheet 12 and then placing a second glass sheet 14 on the interlayer 16. Clamping a vacuum ring 20, 22 around the peripheral edge portion of the assembled stack 18 as shown in FIGS. 2B and 2C to form a seal for applying a vacuum to the peripheral edges of the assembled stack 18. Placing the assembled stack 18 as clamped in the vacuum ring 20 into an autoclave or oven 24. Drawing a vacuum in the vacuum ring 20 via a vacuum line/tube 22 on the vacuum ring. Elevating the temperature in the autoclave to a temperature that is at or somewhat above the softening temperature of the polymer interlayer 16 (the soak temperature). Maintaining the vacuum and soak temperature while maintaining the vacuum in the vacuum ring in order to soften the interlayer 16, de-air the space between the two glass sheets 12 and 14, and bond/tack the softened interlayer 16 to the two glass sheets 12, 14, thereby laminating the assembled stack 18 together. A similar time/temperature regime can be used for a vacuum bag laminating processes. Removing the assembled stack from the autoclave. Removing the vacuum ring. Finally, separating the vacuum ring from the stack. The resulting laminate will be almost clear or clear, especially around the edges, which should be completely sealed. If necessary, the laminate may then be autoclaved at an elevated temperature and pressure to complete and clarify the laminate. As described above, when at least one of the glass sheets being laminated is a thin glass sheet having a thickness not exceeding 1.0 mm, then the presently described procedure may eliminate the need for any subsequent autoclave step.

The present disclosure describes a process in which the assembled stack is laminated in an autoclave. However, in cases where there is no need to pressurize the chamber in which the assembled stack is being laminated, then a more economical oven equipped with vacuum ports to draw a vacuum in the vacuum ring or vacuum bag may be employed in place of an autoclave.

When a thin glass sheet having a thickness not exceeding about 1 mm is used to form a glass laminate, the thin glass sheet (and the resulting glass laminate) is susceptible to deformation from uneven stresses produced in the glass sheets and the assembled stack 18 during the lamination process. The stresses in the assembled stack cause optical distortion and shape variations in the resulting glass laminate. When a typical vacuum bag lamination process is employed to laminate thin glass sheets, random uneven stresses are often generated in the assembled stack being laminated by the vacuum bag as it shrinks. These stresses often cause deformation of the relatively thin and pliable glass in a thin glass laminate as it is being laminated, which deformations remain in the glass laminate following lamination causing the previous mentioned optical distortion and shape variations in the glass laminate. When laminating relatively thick glass sheets having a thickness exceeding 1 mm, the uneven stresses created by the vacuum bag are not large enough to create any significant deformation of the glass sheets or the laminated structure in general due to the rigidity of the thick glass sheets. For vacuum ring processes, the rubber vacuum ring pressing on the assembled stack creates uneven stresses at the periphery of the stack that may cause optical distortion and shape variations in the periphery of the glass laminate, especially when a vacuum is applied to the ring to de-air and laminate/tack the stack. On the other hand, the central portion of the stack experiences uniform vacuum pressure, such that no significant optical distortions occur.

While pliable thin glass sheets are more susceptible to deformation, as described in the present disclosure, flexible thin glass sheets have been found to be easier to laminate due to the thin sheets' ability to conform to the surface that it is being laminated to. The present disclosure describes how to take advantage of this pliable, conformable property of thin glass sheets to laminate products utilizing thin glass sheets while employing a lower vacuum in the vacuum ring or vacuum bag than is typically employed in vacuum ring or vacuum bag lamination processes.

As explained above, in a vacuum ring lamination process, the edges of the stack are subjected to uneven stress from the vacuum ring pressing on the outer periphery of the glass sheets. However, by reducing either the vacuum applied to the vacuum ring or by reducing the pressure/force with which the vacuum ring is clamped on the periphery of the assembled stack, it is possible to reduce the thin glass's and the stack's tendency to deform during lamination. It has been found that by both reducing the vacuum and reducing the clamp pressure of the vacuum ring, a significant reduction in the deformation around the edges of the laminate can be obtained, thus achieving minimal distortion around the edges of the laminate. It is also possible to reduce the stresses and deformation in the laminate even further by reducing the lamination temperature and pressure (e.g. the pressure in the autoclave) applied to the stack.

As described above, pressure may optionally be applied to the central portions of the assembled stack in order to press the central portions of the two glass sheets together by elevating the pressure inside the autoclave 24. However, due to the pliable nature of the thin glass sheets, the assembled stack of the present disclosure has been found to be satisfactorily pressed together, de-aired and tacked simply by applying a vacuum via the vacuum ring while atmospheric pressure is maintained in the autoclave, such an autoclave is not requires and a simple oven with vacuum ports will suffice. Due to their thin flexible/pliable nature, the thin glass sheets 12 and 14 readily form to each other, thereby closing any gaps between the thin glass sheets and the interlayer 16 and eliminating air bubbles. Optionally, it has been found that the pressure inside the autoclave can be reduced compared to typical laminating processes so that the pressure in the autoclave does not exceed about 80 psi, or the step of pressurizing and controlling the pressure within the autoclave may be completely eliminated.

The pliable nature of the thin glass sheets also allow for a lower soak temperature and a lower vacuum pressure compared to typical vacuum ring and vacuum bag laminating processes. For example, thin glass sheets may be laminated in vacuum ring or a vacuum bag process according the present disclosure at atmospheric pressure and a de-air and tack temperature (or soak temperature) not exceeding about 150° C., not exceeding about 120° C., not exceeding about 100° C., in arrange of from about 90° C. to about 120° C., or from about 90° C. to about 100° C. in the autoclave or oven, while applying a vacuum to the peripheral edge of the assembled stack (via the vacuum ring or a vacuum bag) not exceeding about −0.9 bar, not exceeding about −0.6 bar, not exceeding about −0.5 bar, not exceeding about −0.3 bar, or within a range from about −0.2 to about −0.6 bar without an additional subsequent autoclave or oven treatment.

A typical vacuum ring (or vacuum bag) process employs an additional subsequent autoclave step, whereas the previously described de-air and tack may employ a soak temperature of from about 120° C. to 150° C. and a pressure of 150 psi to 200 psi within the autoclave to form the glass laminate without any subsequent processing. The present disclosure thus provides an improved vacuum ring process for producing thin laminated glass structures having improved optical distortion and shape consistency than is possible when using typical vacuum ring process when laminating thin glass sheets having thickness not exceeding 1 mm, without the need for subsequent higher temperature and pressure processing in an autoclave. However, such a subsequent may optionally be employed without departing from the scope of the present description and claims.

### Example 1

Flat thin glass stack of 0.7 mm Gorilla Glass (GG)/0.76 mm Saflex® QB51 acoustic PVB from Solutia Inc./1.6 mm soda lime glass (SLG) were laminated using a vacuum ring lamination process at a vacuum of −0.7 bar, a de-air and tack temperature of 100° C. without any additional lamination pressure, e.g. at atmospheric pressure in an autoclave or oven. The resulting glass laminates were transparent with minimal optical distortion in the central portion of the laminate, while there was visible optical distortion around the peripheral portions of the laminate.

### Example 2

The same thin glass stacks as in Experiment 1 were laminated with a vacuum ring using same process conditions, except that the vacuum was controlled at −0.5 bar. Again the resulting glass laminates were transparent with minimal optical distortion in the central portion of the laminate. The optical distortion around the edges appeared to be improved compared to the laminate of Experiment 1 that employed a higher vacuum.

### Example 3

The same thin glass stacks as in Experiment 1 were laminated with a vacuum ring using the same process conditions, except that the vacuum was controlled at −0.3 bar. The resulting glass laminates again had very minimal optical distortion in the central portion of the laminate. The optical distortion around the peripheral portions of the resulting glass laminates was even better than was achieved with either Experiment 1 or Experiment 2 that employed higher vacuum pressures.

The preceding experiments demonstrate that lowering the vacuum intensity in the vacuum ring to a level not exceeding about −0.6 bar, not exceeding −0.3 bar, or in a range of from about −0.2 bar to about −0.6 bar, or from about −0.2 bar to about −0.3 bar results in less stress in the peripheral portions of the stack during lamination, and better optical distortion around the edges of the resulting glass laminate.

### Example 4

The same thin glass stacks as in Experiment 1 were laminated with vacuum ring using the same process conditions as in Experiment 3 with −0.3 bar, except that the soak temperature is lowered to 90° C. instead of 100° C. The optical distortion at edges of the laminates appeared to be even better than that when processed at 100° C. This experiment demonstrates that lower soak temperatures not exceeding 100° C. or not exceeding 90° C. help mitigate the optical distortion around the edges.

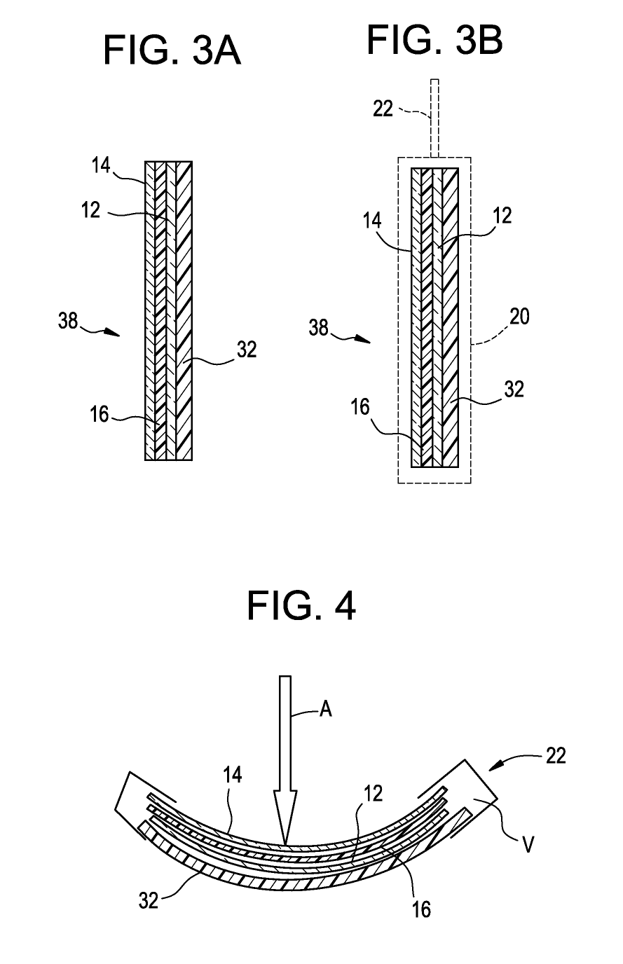

A vacuum ring (or vacuum bag) and reference mold laminating process according to another embodiment of the present description will now be described with reference to FIGS. 3A, 3B, and 4. Such a process may consist of the following steps. Providing a rigid substrate or reference mold 32 having a reference surface 34 in the shape of the desired final laminate shape to serve as a standard surface for desired laminate shape reference and formation. Stacking a first thin glass sheet 12 on top of the reference mold 32. Stacking an adhesive interlayer material 16 on top of the first thin glass sheet. Stacking a second thin glass sheet 12 on top of the interlayer 16 to complete an assembled reference mold/glass/interlayer/glass assembled stack 38. Fitting an appropriate sized vacuum ring 20 around the periphery of the assembled stack 38 (including the rigid substrate). The elastic force of the vacuum ring 20 on the periphery of the stack 38 holds the stack together so that it can be easily handled. If a vacuum bag is used instead of a vacuum ring, then the assembled stack 38, including the reference mold, may be placed into the vacuum bag in a vertical (or horizontal) orientation taking care that the components of the stack do not move relative to one another. Placing the assembled stack 38 into an autoclave or oven. Applying a vacuum in the range of −0.2 bar to −0.6 (or −0.9 bar) to the vacuum ring (or vacuum bag as the case may be). Once a vacuum has been established, atmospheric pressure (or a greater pressure) in the autoclave (or oven) causes the thin glass sheets 12 and 14 and interlayer 16 to bend and assume the shape of the reference mold 32. The stack is then heated to a temperature that is somewhat above the softening temperature of the interlayer material (for example a soak temperature of about 100° C. for a PVB interlayer). Maintaining the elevated soak temperature and the vacuum for a period of time (the soak time) sufficient to at least seal the edges of the laminate or to completely tack the interlayer to the glass sheets (for example a soak time in the range of about 10 minutes to about 60 minutes). A similar time/temperature regime can be used for vacuum bag laminating processes. Removing the assembly from the autoclave. Removing the vacuum ring (or vacuum bag). Separating the vacuum ring (or vacuum bag) from the stack. Finally, separating the reference mold from the glass laminate. The resulting laminate will be almost clear or clear, especially around the edges, which should be completely sealed. If necessary, the laminate may then be autoclaved at an elevated temperature and pressure to complete and clarify the laminate. As described above, when at least one of the glass sheets being laminated is a thin glass sheet having a thickness not exceeding 1.0 mm, then the subsequent autoclave step may be eliminated.

In the process described in the preceding paragraph, depending on the desired final laminate shape, the reference mold 32 may be planar as shown in FIGS. 3A and 3B or it may be formed in a desired curved shape of the final laminate as illustrated in FIG. 4. The curved shape may be a simple curved shape with a single axis and radius of curvature or a complex curved shape with multiple axes and varying radius of curvature or multiple radii of curvature. The reference mold may, for example, be a glass sheet, such as a soda lime glass sheet, which may be about 4 mm to about 6 mm and has been formed to the desired shape using conventional glass forming/shaping processes as are well understood in the industry (such bending and shaping processes as commonly used in the auto glazing industry). The initial shape of the thin glass sheets 12 and 14 placed into the assembled stack may be flat/planar, or the glass sheets may be nominally formed to the desired final laminate shape. It is said that the glass sheets may be nominally formed to the desire final laminate shape because shape variations commonly occur when forming glass sheets into curved shapes causing shape mismatch from one glass sheet to the next. The vacuum simultaneously removes air from between the layers of the laminate stack and causes the flexible glass sheets 12 and 14 to bend and form to the shape of the rigid reference mold 32 and to each other. The elevated soak temperature during the de-air and tack cycle softens the interlayer 16 to tack the glass sheets to the interlayer and bond/laminates glass structure, and also enables the vacuum to remove any gaps/bubbles between the layers of the stack.

The vacuum ring and vacuum bag processes of the present disclosure takes advantage of the pliable, flexible nature of thin glass sheets 12 and 14. The flexible nature of the thin glass sheets enables the glass sheets to conform to the more rigid reference mold 32 and to each other during the de-air and tack portion of the lamination process when a vacuum is drawn on the vacuum ring 22 and the stack is heated in the autoclave (or an oven). Any shape mismatch between the two glass sheets 12 and 14 is eliminated as the pliable glass sheets conform to the reference mold and to each other during the lamination process. Thus, use of the presently described process eliminates the need for precisely matching the shape of the thin glass sheets being laminated. As a result, use of the process of the present disclosure relaxes requirements on precise shape control during the lamination process when thin glass less than 1 mm in thickness is used. Small differences in glass shape that arise routinely during glass forming can be eliminated by taking advantage of the flexible nature of the thin glass sheets. For the lamination of curved thin glass laminates, the initial shape of the thin glass sheets placed in the assembled stack may range between flat, any degree of partial formation toward the desired final shape of the laminate, or complete formation to the nominal/final shape of the laminate. The final shape of the laminate is determined by the reference mold during the de-air and tack portion of the laminating process. This forming and lamination process can be carried out using either vacuum rings or vacuum bags.

### Example 5

Flat thin glass stacks of 0.7 mm Gorilla Glass/0.76 mm QB51 PVB/0.7 mm Gorilla Glass were laminated with a vacuum ring using a reference mold to promote shape consistency. The process conditions are same as in Experiment 3 with −0.3 bar and 100° C. The glass sheets all had approximately the same curvature. Again, transparent laminates with minimal optical distortion around the edges of the sample were achieved. This experiment demonstrates that use of a reference mold reduces deformation and promotes shape consistency while producing a thin glass laminate with enhanced optical properties.

### Example 6

A rigid reference mold with a cylindrical curve having a 60″ radius was made from 4 mm soda lime glass. Stacks were assembled including a first 0.7 mm thick chemically hardened Corning Gorilla glass sheet, a single film of 0.81 mm thick Solutia Saflex QB51 PVB interlayer, and a second sheet of 0.7 mm Gorilla glass sheet. The total thickness of the stacks was 6.2 mm. A properly sized vacuum ring was fitted around the periphery of the stacks. Such a stack is schematically illustrated in FIG. 4. The ring was evacuated to a vacuum level of −0.3 bars. This was found to be sufficient vacuum to properly remove air from the stack and to form the GG/PVB/GG stacks to the shape of the reference mold. This stack was heated at 100° C. for 30 minutes to complete the de-air and tack process. The GG/PVB/GG laminate was separated from the rigid substrate and examined. The laminate was mostly clear with an excellent edge seal.

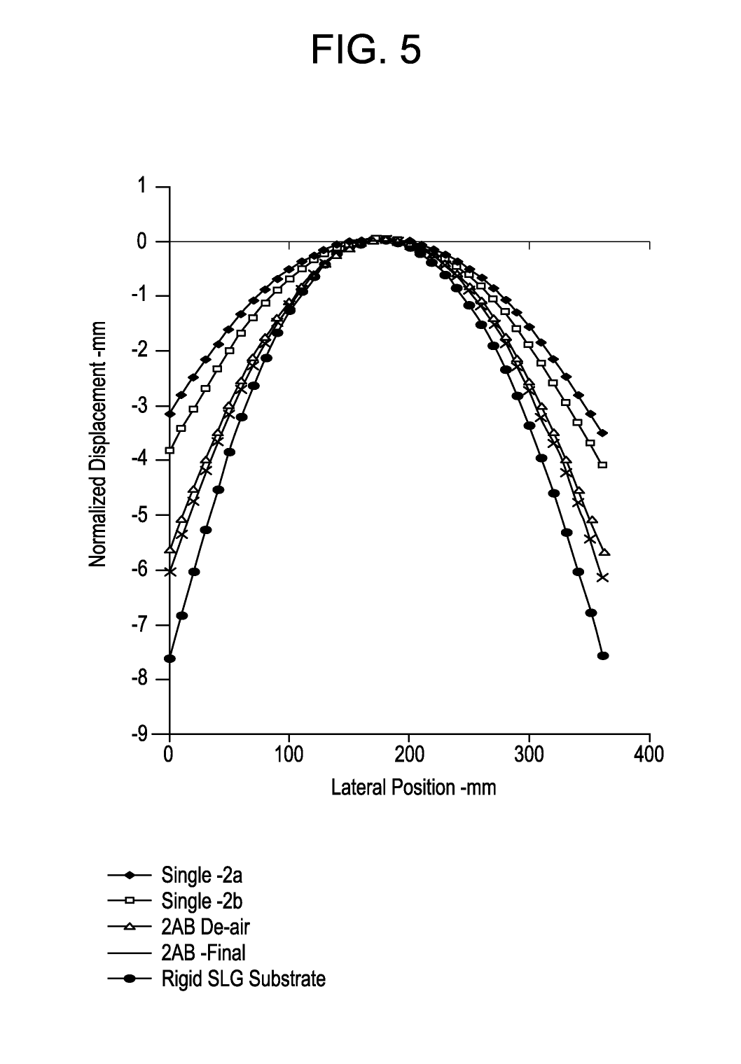

FIG. 5 plots the shape of the initial glass sheets (A and B) in the stack, the shape of the reference mold (E), the shape of the laminate after de-air and tack (e.g. immediately after laminating in an autoclave processing at 130 C and 80 psi. for a 36 minute soak time) (D), and the shape of the laminate after relaxing following lamination in the autoclave (C). The laminates relaxed somewhat back toward the initial glass shape (e.g. from D to C) following de-air and tack. This relaxation effect is exaggerated in this example because of the large difference in initial shape between the thin glass sheets and soda lime glass reference mold. In actual production the degree of relaxation following laminating can be greatly reduced by more closely matching the initial shape of the thin glass sheets to that of the reference mold.

### Example 7

A vacuum ring was clamped around the periphery of the assembled glass/interlayer/glass/reference mold 38 stacks, the vacuum ring was evacuated to a level of −0.3 bar, and the assembled stacks were processed at 80 psi, 130° C. for a 35 minute soak time in an autoclave. The result was laminates with little optical distortion in the center, but severe optical distortion around the edges. This optical distortion extended a significant distance in toward the center. This optical distortion was caused by exudation of the PVB around laminate edges resulting from the combined effects of the clamping pressure of the vacuum ring, softening of the PVB at 130° C., and vacuum applied to the peripheral edges of the stack during autoclaving. Because the laminates were autoclaved with the reference mold in place, the shape of the stack/laminate was essentially identical to the desired laminate shape (e.g. the shape of the reference mold) after de-air and tack.

### Example 8

The same glass/interlayer/glass assembled stacks were laminated using a de-air and tack process consisting of evacuating the vacuum ring to −0.3 bar, cold de-air time of 20 minutes then increasing the temperature to 100 C for 30 minutes to tack the laminate together, but no reference mold or vacuum ring was used during autoclaving. The shape of this laminate relaxed toward the shape of the initial thin glass sheets. No PVB exuded from the side and optical distortion was minimal.

In another embodiment of a vacuum laminating process according to the present disclosure, multiple laminated structures may be laminated/processed as described in relation to FIGS. 3A, 3B and 4 simultaneously in a single vacuum bag or with a single vacuum ring in a single lamination/de-air and tack process. In this way, multiple vacuum bags or vacuum ring lamination operations may be eliminated.

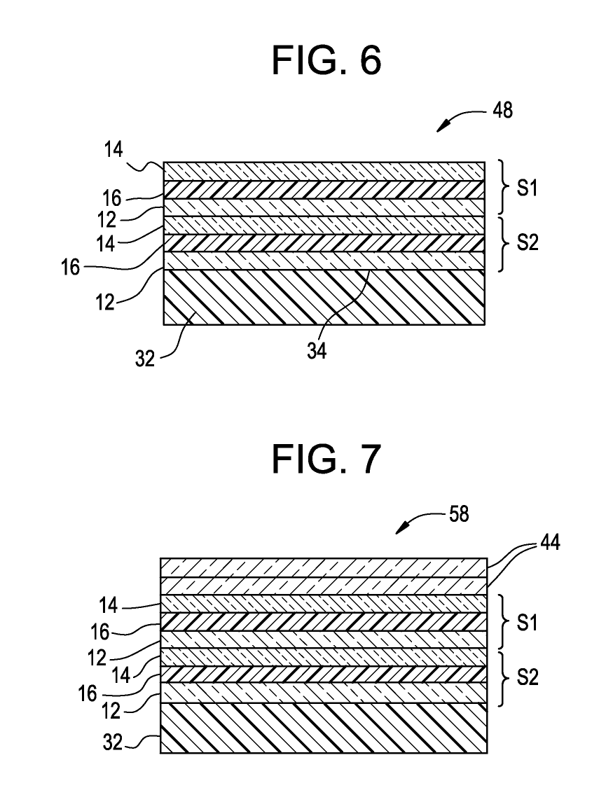

As schematically illustrated in FIG. 6, such a process according to the present disclosure may include stacking multiple glass/interlayer/glass assembled laminate stacks, for example two laminate stacks S1 and S2, one on top of the other, on top of a single reference mold 32 for simultaneous processing as a single assembled stack 48. Placing the assembled stack 48 including the reference mold in a vacuum bag (not shown in FIG. 6) (or clamping a vacuum ring on the periphery of the assembled stacks and the reference mold). Only two laminate stacks S1 and S2 are illustrated in FIG. 6, however, it will be appreciated that several glass/interlayer/glass laminate stacks may be assembled on a single reference mold 32 and processed simultaneously. Placing the vacuum bag containing the assembled stack 48 in an autoclave (the reference mold is inside the vacuum bag). Applying a vacuum to the vacuum bag. Increasing the pressure in the autoclave to a slight soak pressure somewhat above atmospheric pressure, for example a pressure of about 10 psi to about 15 psi. Heating the autoclave (or oven) and the assembled stacks to a soak temperature that is somewhat above the softening temperature of the interlayer material, for example a soak temperature not exceeding 150° C., not exceeding 120° C., not exceeding 100° C., in arrange of from about 90° C. to about 120° C., or from about 90° C. to about 100° C. for a PVB interlayer. Maintaining the soak temperature and soak pressure in the autoclave for a period of time sufficient to at least seal the peripheral edges of the laminate stacks, or to completely tack the interlayer to the glass sheets of the laminate stacks S1 and S2, for example a soak time in the range of about 10 minutes to about 60 minutes. The pressure within the autoclave will cause the thin glass sheets 12 and 14 and the interlayers 16 to bend and conform to the shape of the reference mold 32. Interlayer exudation from the peripheral edges of the laminate stacks S1 and S2 can be prevented by controlling the soak temperature and pressure as described herein.

A similar time/temperature regime can be used for vacuum ring laminating processes. The pressure within the autoclave may remain at atmospheric pressure in a vacuum ring process when laminating thin glass sheets having a thickness of less than 1 mm thick. As such, an oven may be employed in place of a more expensive autoclave. Removing the vacuum bag (or vacuum ring) containing the laminated stacks/laminates from the autoclave. Removing the assembled stack from the vacuum ring. Finally, separating laminated thin glass laminates S1 and S2 from the reference mold 32 and from each other. The resulting thin glass laminates will be almost clear or clear, especially around the edges, which should be completely sealed. If necessary, the laminates may then be autoclaved at an elevated temperature and pressure to complete and clarify the laminates. As described above, when at least one of the glass sheets being laminated in each laminate stack is a thin glass sheet having a thickness not exceeding 1.0 mm, and particularly if both are, then the presently described procedure may eliminate the need for any subsequent autoclave step.

FIG. 7 illustrates an alternative embodiment hereof for simultaneously forming and laminating a plurality of thin glass laminates including the following steps. Stacking a plurality of glass sheet 12/interlayer 16/glass sheet 14 laminate stacks S1 and S1 on a reference mold 32. Stacking a one or more extra glass sheets 44, one on top of the other, on top of the laminate stacks S1 and S2, forming an assembled stack 58 including the extra glass sheets, the laminate stacks, and the reference mold. Placing the assembled stack 58 in a vacuum bag or clamping the assembled stack in a vacuum ring as previously described. Placing the vacuum bag or the vacuum ring containing the assembled stack in an autoclave or oven. Applying a vacuum to the vacuum bag or the vacuum ring. Heating the oven to a soak temperature somewhat above the softening temperature of the interlayers. Maintaining the soak temperature and the vacuum for period of time sufficient to allow the glass sheets to form to the shape of the reference mold and for the interlayers 16 to de-air and tack to the glass sheets. Removing the vacuum bag or ring from the autoclave or oven. Removing the assembled stack 58 from the vacuum bag or vacuum ring. Finally, separating the glass laminates S1 and S2 from each other and from the reference mold and extra glass sheets 44. The glass laminates S1 and S2 are now complete.

Stacking one or a number of extra thin glass sheets 44 on top of the laminate stacks S1 and S2 as illustrated in FIG. 7 serves at least two purposes. The extra glass sheets will conform to the shape of the top laminate stack S2 due to their flexibility. Any uneven or concentrated stresses from the vacuum bag will be more evenly distributed over a larger area as it goes down the layers, thus effectively reducing uneven stress that will cause optical distortion in the laminate stacks S1 and S2. Also, since surfaces of all the glass sheets but the top extra glass sheet 44 are pressed against by another glass sheet 44, 12 or 14, and not by the vacuum back or vacuum ring, there is no uneven surface pressing directly against any of the glass sheets 12 or 14 forming the laminate stacks to create deformation that leads to optical distortion.

The process described herein for laminating and shaping multiple laminates or multiple thin glass sheets simultaneously are most effective for laminates that contain thin glass sheets having a thickness of less than 1.0 mm and laminates formed of such thin glass sheets, because such thin glass sheets readily flex and conform to the shape of a mating sheet of glass and to a reference mold. By providing a firm or rigid reference mold, all the thin glass sheets in the assembled stack will be pressed against each other and will all assume the shape of the reference mold, even if there is a mismatch in the initial shape of the thin glass sheets in the assembled stack. Moreover, thin glass sheets are easily subject to deformations by the uneven stress from the bags under vacuum and from vacuum rings, which stresses are substantial reduced or eliminated by the processes described herein. Also, for assembled/laminate stacks including thicker glass sheets, additional pressure might need to be applied to the assembled stack, in addition to the vacuum applied to the vacuum bag or ring, to conform to thicker glass sheets to the reference mold. However, vacuum alone may be enough for samples containing all thin glass sheets, thus save time and resources over laminating relatively thick glass sheets.

### Example 9

Three laminates containing all two 0.7 mm flat sheets of Corning Gorilla glass and a SentryGlas Plus film interlayer from Dupont were simultaneously laminated on a single reference mold in a single vacuum bag. 4 mm shaped soda lime glass served as the reference mold and three 0.7 mm Gorilla Glass were placed on top of the laminate stacks to reduce uneven stress from the vacuum bag imposes to the laminate stacks. Only about −0.5 bar of vacuum (−15″ Hg) was applied to the vacuum bag and no additional pressure was applied outside the vacuum bag in the autoclave. The assembled stack was heated to 210° F. and soaked for one hour before it was cooling down and removed from the autoclave. The samples were transparent and there was no bubble, and the optical distortion was much improved than in a single sample made using vacuum bag.

The reference mold has been described herein as being formed of soda lime glass, but the reference mold in all the embodiment herein could be formed of other suitable relatively stiff materials that will hold their shape at the soak temperature, such as metal, ceramic, glass ceramic, different glass, etc.

A thermoplastic material such as PVB may be applied as a preformed polymer interlayer. The thermoplastic layer can, in certain embodiments, have a thickness of at least 0.125 mm (e.g., 0.125, 0.25, 0.375, 0.5, 0.76, 0.81, 1.14 or 1.52 mm) The thermoplastic layer can cover most or, preferably, substantially all of the two opposed major faces of the glass. It may also cover the edge faces of the glass. The glass sheet(s) in contact with the thermoplastics layer may be heated above the softening point of the thermoplastic, such as, for example, at least 5° C. or 10° C. above the softening point, to promote bonding of the thermoplastic material to the glass. The heating can be performed with the glass ply in contact with the thermoplastic layers under pressure.

Select commercially available polymer interlayer materials 16 that may be used with the process and apparatus described herein include PVB, EVA, polyurethane, Ionomers (such as SentryGlas® from DuPont) and other thermoplastic bonding films. One or more polymer interlayers may be incorporated into a glass laminate. A plurality of interlayers may provide complimentary or distinct functionality, including adhesion promotion, acoustic control, UV transmission control, and/or IR transmission control.

This present disclosure describes vacuum ring and vacuum bag lamination process conditions that achieve a transparent glass laminate with improved optical distortion and shape consistency compared to typical vacuum ring mold processes by taking advantages of the thin glass's flexibility. The presently disclosed processes are capable of preserving the pristine optical quality of the laminates in terms of optical distortion especially when thin glass is involved. The present disclosure teaches how to utilize both vacuum ring and vacuum bag process to directly produce transparent glass laminates with improved optical distortion and shape consistency when thin glass is used in a single step, thus eliminating the additional autoclave step at higher temperature and pressure to save time and resources. The present disclosure also teaches how to use a single reference mold to promote shape consistency of laminates made from all thin glass sheets, especially when making a curved sample. The present disclosure also teaches how to drastically reduce the time, labor, and resources needed for the production as compared to the production processes by processing a plurality of laminate stacks simultaneously. The present disclosure describes processes that not only lower the vacuum applied to the vacuum ring or vacuum bag and the clamping pressure of the vacuum ring compared to typical thick glass processes, but also lower the temperature and pressure of the autoclave cycle when laminating thin glass, thereby reducing the time and resources required to laminate and form the thin glass laminates. Certain processes of the present disclosure also improve the optical quality of the laminates in terms of optical distortion by using a reference mold and optional additional thin glass sheets on top of the laminate stacks. It is also possible to apply the basic principles of this description and devise some apparatuses or processes to facilitate or actually perform the lamination using different bonding films/interlayers and different thin glasses that may or may not be chemically strengthened. The present disclosure also describes and includes the improved thin glass laminates produced from this improved process.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A process of forming a glass laminate characterized by the steps of:
providing a first glass sheet, a second glass sheet and a polymer interlayer, wherein at least one of the first glass sheet and the second glass sheet has a thickness not exceeding 1 mm;
stacking the interlayer on the first glass sheet and stacking the second glass sheet on the interlayer forming an assembled stack;
applying a vacuum to a peripheral edge of the assembled stack; and
heating the assembled stack to a soak temperature at or above the softening temperature of the interlayer; and
maintaining the vacuum and the soak, temperature for period of time (a soak time) sufficient to de-air the interlayer and tack the inter layer to the first glass sheet and the second glass sheet.

2. The process as in claim 1, wherein both the first glass sheet and the second glass sheet have a thickness not exceeding 1 mm.

3. The process as in claim 1, wherein both the first glass sheet and the second glass sheet are chemically strengthened glass sheets.

4. The process as in claim 1, further characterized by the step of placing the assembled stack in and autoclave at a pressure not exceeding 80 psi during the soak time.

5. The process as in claim 1, wherein the soak temperature does not exceed about 120° C., 100° C. or 90° C.

6. The process as in claim 1, wherein the vacuum applied to the peripheral edge of the assembled stack does not exceed about −0.6 bar, about −0.5 bar or about −0.3 bar.

7. The process as in claim 1, wherein the step of applying a vacuum is characterized by clamping vacuum ring to the peripheral edge portion of the assembled stack and applying a vacuum in the vacuum ring.

8. The process as in claim 7, wherein the step of heating comprises heating the assembled stack to a soak temperature not exceeding 150° C.

9. The process as in claim 1, further characterized by:
placing the assembled stack in and autoclave; and
maintaining a pressure within the autoclave in a range of from about 150 psi to about 200 psi during the soak time.

10. The process as in claim 1, further characterized by the step of:
providing a reference mold with a reference surface having shape substantially matching a desired shape of the glass laminate to form the assembled stack; and
the step of applying a vacuum applies a vacuum to the peripheral edge of the assembled stack including the reference mold.

11. The process as in claim 10, further characterized by the step of:
stacking two or more assembled stacks on the reference surface of the reference mold; and
the step of applying a vacuum applies a vacuum to the peripheral edge of all of the assembled stacks and the reference mold simultaneously.

12. The process as in claim 1, wherein the stacking steps further include stacking at least one extra thin glass sheets on top of the assembled stack; and
wherein the step of applying a vacuum includes placing the assembled stack in one of a vacuum bag and a vacuum ring and applying a vacuum to the one of a vacuum bag and a vacuum ring.

13. The process as in claim 1, wherein the reference mold is formed of a shaped soda lime glass sheet having a thickness of about 4 mm to about 6 mm thick.

14. The process as in claim 1, wherein the step of applying a vacuum includes placing the assembled stack in one of a vacuum bag and a vacuum ring and applying a vacuum to the one of a vacuum bag and a vacuum ring.

15. The process as in claim 1, wherein the interlayer is formed of a polymer from the group consisting of standard polyvinyl butyral (PVB), acoustic PVB, ethylene vinyl acetate (EVA), thermoplastic polyurethane (TPU), or an ionomer.
